(19) United States
(12) Patent Application Publication
(10) Pub. No.: US 2010/0161471 A1
(43) Pub. Date: Jun. 24, 2010

(54) Method and system for forecasting financial statements and analysis there of

(76) Inventor: Kerry Fendick, Highlands, NJ (US)

Correspondence Address: IPR WORKS, LLC, P.O. BOX 303, ATLANTIC HIGHLANDS, NJ, 07716, US

(21) Appl. No.: 12/600,269

(22) PCT Filed: Jun. 30, 2008
(86) PCT No.: PCT/US08/68865

§ 371 Date: Nov. 15, 2009

Related U.S. Application Data
(60) Provisional application No. 60/947,446, filed on Jul. 1, 2007.

(51) Int. Cl. G06Q 40/00; G06F 3/048

(52) U.S. Cl. 705/35; 715/854

(57) ABSTRACT

System and method for forecasting financial performance of a firm in the form of a financial statement and analyzing data-defined dependencies among its own line items and between its line items and those of other firms. Inputs comprise financial statements of a given firm and additionally of other firms, as well as macroeconomic data and user-provided forecasts of particular line items. A forecast of the complete or partial financial statement for the given firm is generated. The system and method also provide quantification of data-defined dependences between line items of the same or different firms. Data-defined dependencies are selectively displayed, and users can be interactively navigated through the chains of dependencies. The invention enables users to create alternative forecasts, each corresponding to a user-provided forecast for particular set of line items.

### CROSS REFERENCE TO RELATED APPLICATIONS

This application claims the benefit of the U.S. Provisional Patent application US60/947,446 entitled “Method and system for forecasting financial statements and analysis thereof”, filed on Jul. 1, 2007.

### FIELD OF THE INVENTION

This invention relates to a method and system for forecasting a company's financial statements as well as for analyzing the forecast.

### BACKGROUND OF THE INVENTION

Accurate forecasts of corporate financial performance are highly valued by investors as inputs for investment decisions. As Burton Malkiel states in the book, A Random Walk Down Wall Street, “All investment returns . . . are dependent, to varying degrees, on future events. That's what makes the fascination of investing. It's a gamble whose success depends on the ability to predict the future.” A firm's financial performance can directly determine investment returns, as when profits are distributed to shareholders as dividends or when a firm declares bankruptcy after running out of cash. A firm's financial performance can also influence investment returns by changing perceptions about a firm's inherent value, as when investors bid up the price of a firm's stock when its earnings per share were higher than expected.

The importance to investors of accurate information about financial performance is underscored by government requirements for public companies to disclose, audit, and certify financial statements on a regular basis. In the United States, the Security and Exchange Commission (SEC) requires publicly traded U.S. corporations to file financial reports quarterly following generally accepted accounting principles (GAAP). GAAP financial reports are a common language for investors, analysts, auditors, and management to describe the performance of a firm. A public repository of historic financial statements for companies traded in the United States is maintained at The United States Securities and Exchange Commission Electronic Data Gathering, Analysis and Retrieval (SEC EDGAR).

A GAAP financial report comprises a firm's Income Statement, Balance Sheet, and Statement of Cash Flows, as well as notes from the firm's management, for a particular accounting period. The usual accounting period in the U.S. is a fiscal quarter, and the SEC requires U.S. public companies to file financial statements quarterly. The Income Statement summarizes revenues & costs of goods sold, operating expenses, and the resulting overall profits or losses during the period covered by the financial statement. The Balance Sheet summarizes the firm's assets and liabilities at the end of the period covered by the financial statement. The Statement of Cash Flows summarizes the increase or decrease in the firm's cash over the period covered by the financial statement associated with profits, losses, investments, and other financial activities. Whereas the Income Statement and Statement of Cash Flows describe change or increments in quantities over the course of the accounting period, the Balance Sheet describes a snapshot of the firm's accounts and inventories at the end of the accounting period. Such an elaborate structure has evolved because none of the individual components alone provide an accurate view of a firm's health. The importance to investors of understanding each of the components comprising a GAAP financial statement is underscored by the requirement by the SEC for firms to provide a full GAAP report every quarter.

Much of the rest of the world uses the International Financial Reporting Standards (IFRS) instead of GAAP as the accounting standard. An IFRS report has a similar structure but also includes either a statement of changes in equity or a statement of recognized income or expense.

The components of a financial statement, whether GAAP or IRFS, whether the Income Statement, Balance Sheet, etc., comprise a set of numerical line items. Some line items can be derived from others. For example, Gross Margins, a line item commonly provided on the Income Statement, can be derived by subtracting the Cost of Goods Sold from Total Operating Revenues, two other line times from the Income Statement Likewise, if one knows Total Operating Revenues and Gross Margins, one can derive the Cost of Goods Sold. We say that such a dependency between line items is definitional. A line item can exhibit a definitional dependency not only on other line items from the same financial statement but also on line items from financial statements of the same firm from earlier accounting periods. One can derive, for example, the Change in Cash on the Cash Flow Statement using the information from the Balance Sheet about the amount of Cash held by the firm at the ends of successive accounting periods.

Macroeconomic data is created by institutions such as government agencies in analogous form to the financial statements of companies. For example, the Gross Domestic Product of a country is analogous to line items from the Income Statements of a firm. Like the line items of the financial statements of firms, some macroeconomic data is also definitionally related to other macroeconomic data. Public repositories of macroeconomic data also exist. For example, the Federal Reserve Bank of St. Louis provides a repository of historic U.S. macroeconomic data. Historic macroeconomic data is typically displayed as a set of line items.

Financial statements of firms and macroeconomic data of countries naturally lend themselves to representations in spreadsheets. In a spreadsheet representation of a financial statement, it is common to arrange the line items vertically. When representing multiple accounting periods for a given firm in a spreadsheet, it is also natural to arrange the financial statements for different accounting periods as side-by-side columns. If the spreadsheet embeds formulas in its logic corresponding to the definitional relationship, then tools included in some common spreadsheet programs can be used to navigate through chains of such relationships. For example, the “Formula Auditing Tools” supported by the Microsoft Excel spreadsheet program shows arrows with heads terminating at the selected line item (or cell) and tails emanating from all line items that were used as input by the formula that calculated the selected one. Likewise, the “Formula Auditing Tools” can show arrows with tails emanating from the selected line item and heads terminating at all line items calculated by formulas that use the selected one as input. When a formula explicitly uses a sequence of line items as input (i.e., a given number of contiguous entries in a row or column), the corresponding arrows emanate or terminate at a box that surrounds the sequence. By applying such auditing tools iteratively, a spreadsheet user can explore chains of dependencies, for example, revealing a first set of line items that were used as input to compute a given line item, then revealing a second set of line items that were used as input to compute a given line item from the first set, and so on.

The management of a firm will commonly create “bottoms-up” forecasts of the line items of its financial statement for one or more accounting periods into the future. A bottoms-up forecast aggregates fine-grained data about the firm's operations: sales forecasts per customer or region, cost projections and inventory levels per product line, outstanding purchase orders, and so on. Such operational data is typically not available to the public. It may include information from other firms that is also not available to the public. A sales forecast, for example, may incorporate proprietary information shared by the firm's customers about their purchasing plans. The list of a firm's customers itself may itself not be available to the public. Several software vendors provide spreadsheet-based tools for aggregating bottoms-up information to create financial forecasts. Quantrix and Whitebirch Software are examples of such vendors.

Many line items in financial statements that are not definitionally related are nonetheless related by common finer-grained information on which they depend. Revenues and Cost of Goods Sold, for example, both depend on the number of units sold and hence both tend to move in a correlated fashion from one accounting period to another. Likewise, line items in the financial statements of different firms may exhibit correlations because they present the same information from different angles. Sales of items contributing to the Revenue of one firm will contribute to the Cost of Goods Sold of other firms that buy them. As noted in 1972 by J. W. Elliot, “many aspects of corporate financial performance are jointly determined and thus can only be reliably explained in the context of a multiple-equation model which deals with all major aspects of joint behavior.”

The forecast financial statements created through bottoms-up analysis by the firm's management are typically not available to the public in their entirety. Rather, the public guidance provided to investors by the firm's management typically consists of a small subset of a financial statement—perhaps only Revenues and Profit (or Loss) per Share along with some qualitative statements about a few other items of particular note. The price of a firm's stock is often affected by whether the firm ends up missing, meeting, or beating its “numbers” provided in past guidance by management. Therefore, many investors effectively place bets through their buying and selling decisions on the accuracy of the guidance. They must do so, however, without the benefit of the fine-grained operational data at the disposal of the firm's management.

To attempt to meet the needs of investors to assess the accuracy of guidance provided by a firm's management, analysts often provide their own guidance. Like guidance from management, guidance from analysts typically addresses a small subset of line items from a financial report, along with qualitative statements about other line items of particular note. As a result, although guidance from analysts provides an investor with a second opinion, it typically illuminates only a small fraction of the joint behavior that characterizes a firm's performance. Furthermore, it does not provide investors with a means to inject their own speculation about future events to modify the forecast. If, for example, you believe that revenues that will be reported by Apple will come in at the high end of guidance of analysts, does that mean that revenues of Apple's suppliers also will come in at the high end of guidance? Neither guidance from analysts nor guidance from the firm's management provides a comprehensive way to answer such questions.

Fortunately for investors, publicly available financial reports, together with publicly available macroeconomic data, provide a wealth of information that can be used to create financial forecasts. This information includes not only financial reports for the given firm over long history of accounting periods, but also financial reports from thousands of other firms. Nevertheless, most individual investors lack the means to create coherent forecasts from this wealth of information or to identify correlations resulting from jointly-determined behavior. Software tools or services are not available to investors today for this purpose. Nevertheless, known statistical techniques exist to create parametric multi-dimensional models fitting historic line items, projecting future line items, and quantifying correlations between line items. The model's parameters optimize the model's fit of the model to historic data. Multivariate Linear Regression Analysis is one such well known multi-dimensional model.

The sequence of the same line item from successive financial statements of a given firm over multiple accounting periods is an example of a time series. The sequence of Total Operating Revenues reported on a firm's Income's Statements over the 16 quarters from January 2004 through October 2007 is a time series. The sequence of logarithms of those Total Operating Revenues is also a time series. Taking the logarithm of a time series that exhibits exponential growth result in a time series that grows linearly. Additional time series may be created by combining multiple line items of the same or multiple time series. Time series created through transformations of the original data are definitionally related to the original data. It is common practice in statistical data analysis to include such transformation as part of multi-dimensional models of time series. For example, it is common practice to combine transformations to linearize time series with Multivariate Linear Regression Analysis to create a multi-dimensional model. Each dimension of the multi-dimensional model then corresponds either to an original or transformed time series of the input.

It is also common practice in the statistical data analysis of times series and creation of econometric models to include definitional dependencies as part of a multi-dimensional model. For example, a multi-dimensional model may use Multivariate Linear Regression Analsis to project a subset of line items and use definitional dependencies to project the remainder of the line items. This assures that the projections are consistent with the definitional dependencies among its constituents.

A multi-dimensional model for multiple time series can incorporate user forecasts of line items by treating the forecasted line items in the same way as past observations, i.e., by treating the forecasted line items as an extension of the historic time series. Incorporating forecasts provided by users for particular line items can affect the forecasts generated by the multi-dimensional model for other line items.

Multi-dimensional models can reveal statistical correlations between the multiple times series that they fit. In particular, the accuracy of the model in fitting a given time series or set of time series will depend more on some of the time series included in the model's input than on others. The strength of the dependency of a first time series on a second time series can be quantified, for example, by how much the second time series, when included in the model, improves the model's approximation to the first time series. We say that such a dependency is data-defined, because its strength is not known in advance, but is rather determined by historic data. When we speak of data-defined dependencies of a particular line item (whether historical or forecasted), we mean the data-defined dependencies of the time series associated with that line item. By tracing data-defined dependencies, the user may suggest relationships between data that are not known in advance. The model may reveal, for example, strong data-defined dependencies between the Total Operating Revenue of a chip manufacturer on the Cost of Goods Sold of a particular telecom equipment vendor, thus suggesting that the telecom equipment vendor is a customer of the chip vendor. The strength of a data-defined dependency of one line item on another need not be transitive.

Data-defined dependencies are dependencies of degree. A line item may have data-defined dependencies of some degree or another on every other time series used as input by the multi-dimensional model. If a given line item is projected by a multi-dimensional model, a technique such as Excel's Formula Auditing Tools may be able to show the user what other line items were used as input to the multi-dimensional model, but no analogous tool exists to identify the particular line items on which the given item has strong data-defined dependencies.

In summary, guidance on a firm's future financial performance provided by the firm's management or by analysts usually characterize a much more narrow set of metrics than regulatory agencies have deemed necessary through accounting standards for providing a well-rounded assessment of a firm's financial health. For a more comprehensive assessment of a firm's future financial health, investors require tools not existing today to provide forecasts of all line items of a financial statement or user-defined subsets of its line items. The invention allows the user to create such comprehensive forecasts based on publicly available and investor-provided information without requiring the fine-grained, bottoms-up operational data used by a firms management to create similarly comprehensive forecasts for their internal use. The invention enables the user to tailor the input and output to their interests, incorporate user-supplied forecasts of particular line items into the forecast of the remaining line items, and explore chains of data-defined dependencies among the given firm's line items and between those of the given firm and other firms. When data-defined dependencies are quantified, the invention provides a means to selectively display only those data-defined dependencies with strengths above an absolute or relative threshold. The invention also advantageously enables users to create alternative forecasts for financial statements, each corresponding to a different set of forecasts provided by the user for particular line items. Additional uses of the invention's output include forensic accounting, auditing, sanity check for bottoms-up forecasts, and analysis of a firm's customers, suppliers, and competitors as input into operational decisions.

### SUMMARY OF THE INVENTION

This invention provides a system and method for forecasting financial performance of a firm in the form of a financial statement and identifying data-defined dependencies among line items of that statement and between those of that statement and statements of other firms. The system's inputs comprise financial statements of a given firm covering multiple accounting periods and may additionally comprise financial statements for other firms covering multiple accounting periods, as well as time series of macroeconomic data and user-provided forecasts of particular financial-statement line items. The system generates a forecast of all line items of the financial statement of the given firm or a user-defined subset of its line items for one or multiple accounting periods. The system also quantifies data-defined dependences between line items of the same or different firms. When data-defined dependencies are quantified, the invention provides a means to selectively display only those data-defined dependencies with strengths above an absolute or relative threshold. The invention also enables users to create alternative forecasts for a firm's financial statement or its user-selected line items of interest, each alternative forecast corresponding to a different set of user-provided forecasts for particular line items.

### BRIEF DESCRIPTION OF THE DRAWINGS

FIG. 1 illustrates, in accordance with one embodiment of the invention, a system for forecasting financial statements and for identifying data-defined dependencies between line items of those statements.

FIG. 2 illustrates, in accordance with one embodiment of the invention, a method for forecasting financial statements and providing analysis of the forecasted statements.

FIG. 3 illustrates, in accordance with one embodiment of the invention, an example of financial statements from one firm used as input.

FIG. 4 illustrates, in accordance with one embodiment of the invention, an example of user-controlled filtering of input.

FIG. 5 illustrates, in accordance with one embodiment of the invention, an example of user-controlled selection of line items of interest and the resulting forecasts for each.

FIG. 6 illustrates, in accordance with one embodiment of the invention, an example of a fit of a historic time series of line items by a multi-dimensional model and use of the same model to forecast the value of the line item for one accounting period into the future.

FIG. 7 illustrates, in accordance with one embodiment of the invention, an example of guiding the user from on line item to another based on a data-defined dependency meeting a criteria.

FIG. 8 illustrates, in accordance with one embodiment of the invention, an example of navigation to reveal a chain of data-defined dependencies.

FIG. 9 illustrates, in accordance with one embodiment of the invention, an example of a user-provided forecast added to the input.

FIG. 10 illustrates, in accordance with one embodiment of the invention, an example of the alternative forecast resulting from inclusion of a user-provided forecast.

### DETAILED DESCRIPTION OF THE INVENTION

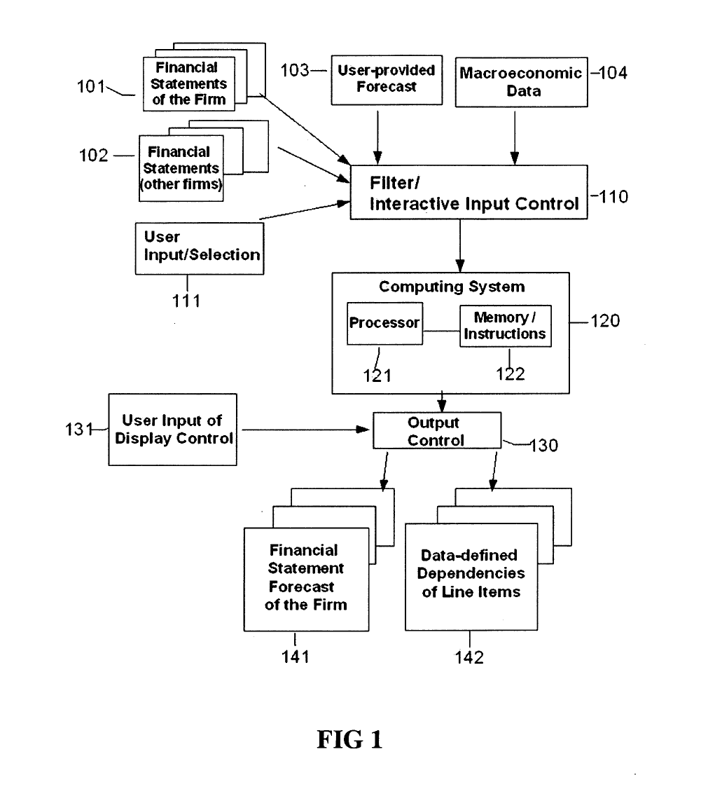

An example of the system used in the invention is illustrated in FIG. 1. The system embodied in FIG. 1 reads in input that the user can filter and control, processes the input using a computing system, and creates output that the user can also control.

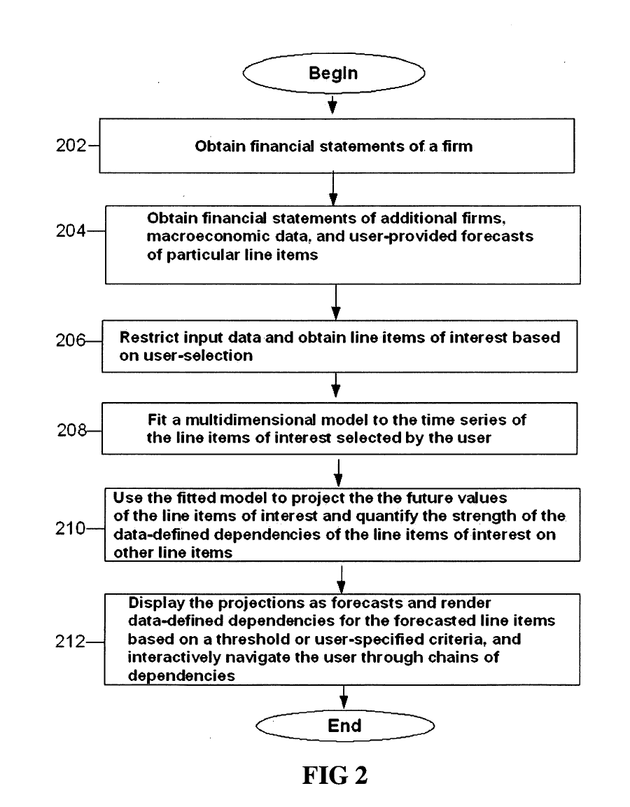

An example of the method used in the invention is illustrated in FIG. 2. The method in FIG. 2 reads in input including financial statements for a firm, the forecast of which are to be included in the output, enables the user to restrict the input data to a subset, uses a multidimensional model fitting the line items of interest as a function of the input to create projections and quantify interdependencies. The method displays a forecast consisting of a subset of those projections and quantifications as controlled by the user.

The invention uses as input the line items of historical financial statements from a given firm for multiple periods. The invention also optionally uses as input the line items of financial statements from other firms for multiple periods, line items of macroeconomic data for multiple periods, and user-provided forecasts of particular of those line items. The sequence represented by the same line item for multiple periods is a time series. Hence, the invention uses as input time series of line items for a given firm, optionally time series of line items for other firms, optionally time series of line items of macroeconomic data, and optionally user-provided forecasts extending some or all of those time series into the future.

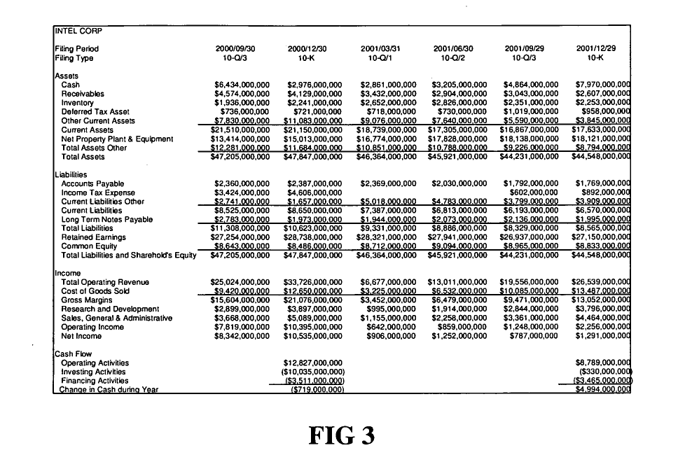

A financial statement is defined here as a set of line items—as specified by an accounting standard—for a particular accounting period. FIG. 3 shows an example of historical financial statements from Intel. Each column in FIG. 3 with line items from a given fiscal quarter comprises one financial statement. The invention may include such financial statements from many firms as input. For each included firm, the input must consist of financial statement from multiple accounting periods proceeding the period(s) for which the forecast is desired.

The invention's input may include entire repositories of public financial statements (e.g., the entire SEC Edger repository) or subsets as pre-specified by the implementation or defined by the user. The user may restrict, or filter, input from a repository so that it consists of a particular list of companies or particular classes of companies, e.g., under Standard Industry Classifications used by SEC Edgar. The user may also filter input from a repository or a particular firm so that it consists of a subset of components of each financial statement, e.g., only Income Statements.

The invention's input may include entire repositories of public macroeconomic data or filtered subsets as pre-specified by the implementation or specified by the user.

The means for reading in the invention's input include but are not limited to parsing through on-line public repositories, downloading data for one or multiple periods, and manual input by the user.

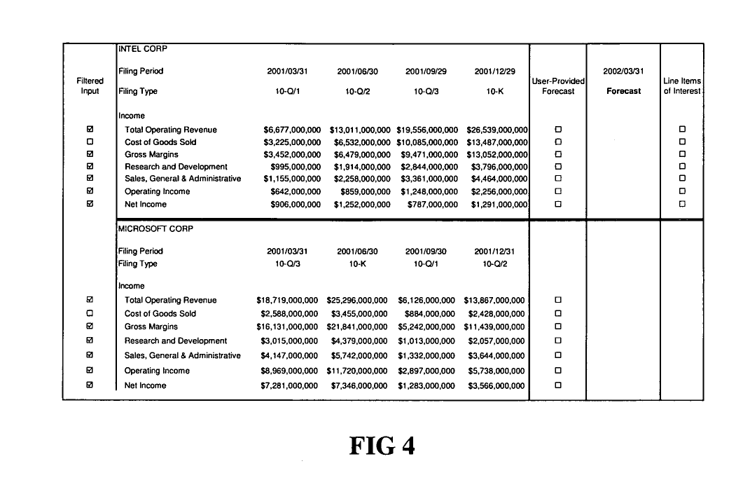

The invention's filtering of input may include selection of particular subset of line items of a given firm. FIG. 4 shows an example in which the filtered input consists of a user-selected subset of line items of the Income Statements of two firms, Intel and Microsoft.

The invention's output includes forecasts of line items of a given firm for one or more accounting periods occurring after the accounting periods for which historic data were included in the input. The forecasted line items may comprise all line items of a financial statement for a given firm or user-selected line items of interest.

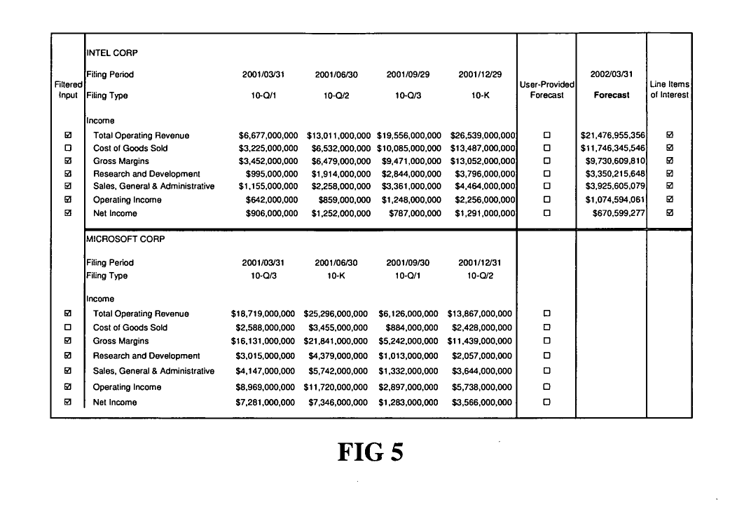

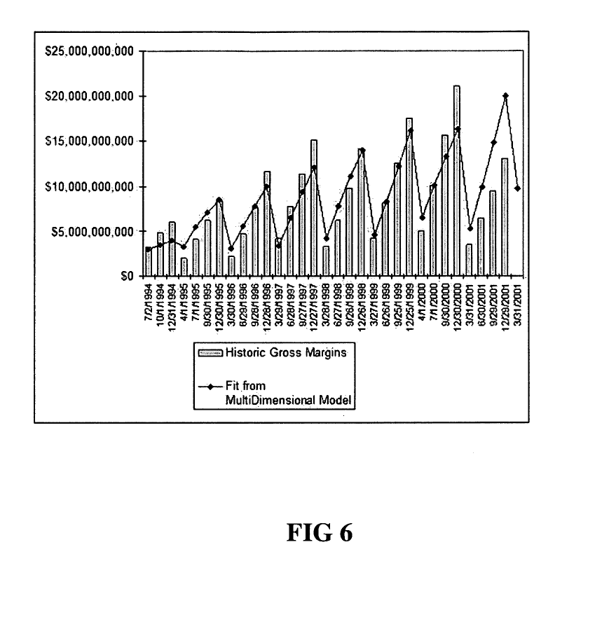

The invention applies a multi-dimensional model to time series from the input. A multi-dimensional model is defined here as any function, formula, or algorithm capable of autonomously creating an approximation, or fit, of the time series of the line items of interest as a function of the input and also capable of projecting future values for those fitted time series. Known methods exist for constructing multi-dimensional models with the ability to fit one or more time series using arbitrary numbers of times series as input and to project future values for those fitted time series. The invention uses the projections of the multi-dimensional model for one or more line items of interest as its forecast. FIG. 5 show an example of a forecast for the selected line items of interest for one accounting period beyond the historic input. FIG. 6 shows an example of a fit of a multi-dimensional model for the historic time series from FIG. 5 corresponding to the Gross Margins, as well as the projection for Gross Margins for the next accounting period. The vertical bars in FIG. 6 represent the historic time series. The final point on the line in FIG. 6 represents the projection, and the preceding points on the line represent the fit to the historic data.

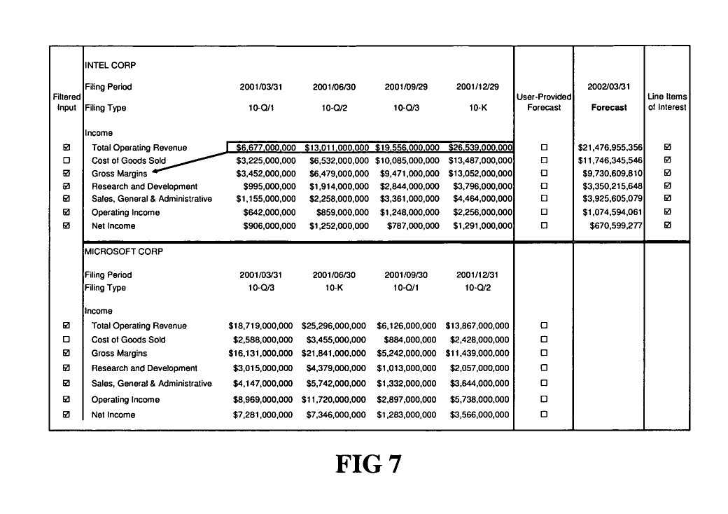

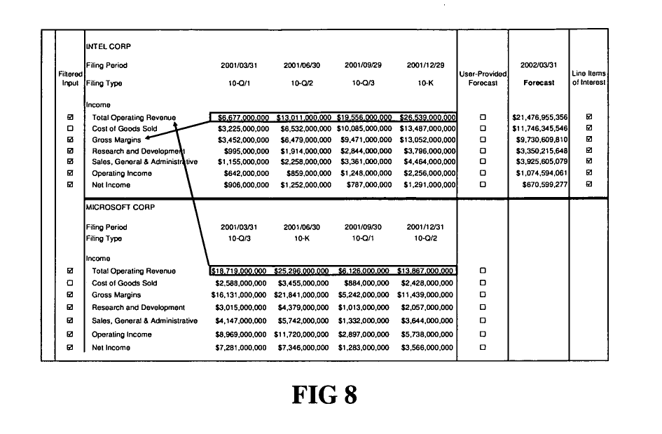

The invention also uses a multi-dimensional model to quantify the strength of data-defined dependencies of different line items. A data-defined dependency is a quantification of the importance of a particular time series to the accuracy of the fit by the multi-dimensional model of a given other time series. Known methods exist for constructing multi-dimensional models with aforementioned characteristics and the ability to quantify the data-defined dependencies. The invention provides a means to display only those data-defined dependencies with strengths above an absolute threshold or among the top N dependencies, where N is a parameter of the model, and to guide the user from one line item to a successive one when the data-defined dependency on the successive one meets a criteria. FIG. 7 shows an example in which the strongest data-defined dependency for the Gross Margins line item for Intel is identified. It is the Total Operating Revenue for Intel. FIG. 8 shows an example in which the strongest data-defined dependency for the Total Operating Revenue for Intel is also identified. It is the Total Operating Revenue for Microsoft. A string from one line item to the next of dependencies is a chain. FIG. 8 displays a chain of data-defined dependencies of length two.

The invention quantifies data-defined dependencies iteratively by quantifying one or more data-defined dependency for a particular line item as a first step, then, for each of the line items identified in the first step, further quantifying one or more data-defined dependency as a second step, and so on. Navigation is the process of iteratively guiding the user from one line item to a successive line item based on a data-defined dependency. Examples of navigation includes the case where the data defined dependencies in each successive step are displayed only when interactively queried by the user and also include the case where the data defined dependencies for each line item in each successive step are displayed only when interactively queried by the user. In this last case, a chain is displayed step by step by querying for the data defined dependencies for a single line item from each step.

The means for entering the invention's input and displaying the invention's output include but are not limited to: Graphical User Interfaces, spreadsheets, tabular interfaces including html and xml, interactive interfaces in which the user is queried for information, interfaces providing the user with control over the format, and standardized formats including the Extensible Business Reporting Language (XBRL). The invention may also read in input from, and generate output to, a database.

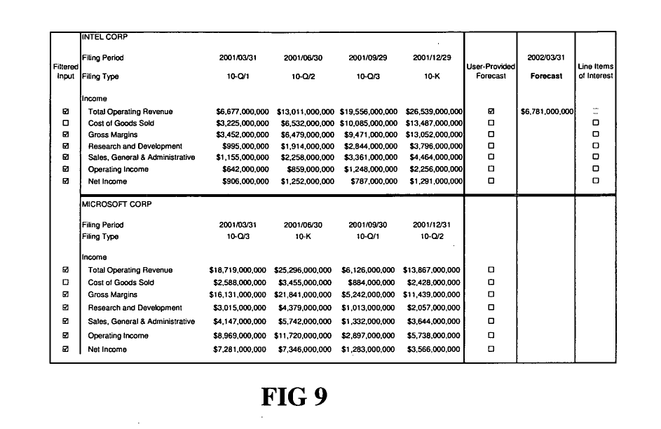

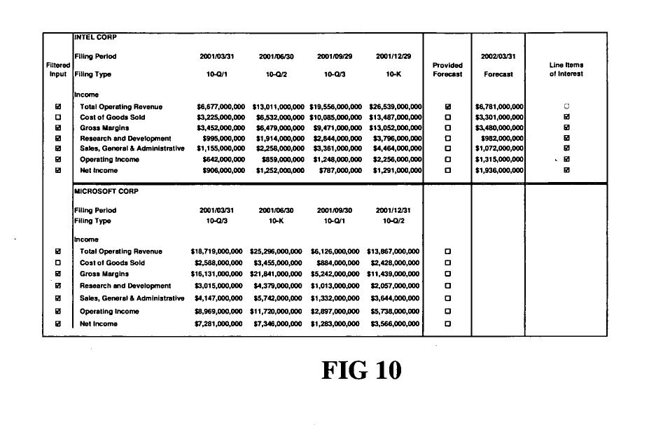

The invention enables the user to input forecasts of particular line items, which are then treated by the model as an extension of historical time series and used to create alternative forecasts of other line items. FIG. 9 shows an example of a user-provided forecast for the Total Operating Revenue for Intel. FIG. 10 shows an example of the resulting alternative forecast for the line items of interest for Intel.

In one embodiment, the multi-dimensional model used by the invention includes mathematical transformations applied to each of the line items in particular time series from the input.

In one embodiment, the multi-dimensional model used by the invention uses definitional dependencies to compute some projected line items based on other projected and historic line items.

In one embodiment, the invention is implemented as a web based service or client-server architecture over networking.

In one embodiment, user-provided forecasts of particular line items are created by aggregating other information that is input from the user.

In one embodiment, the financial statements used in the forecasts are displayed in spreadsheet format and a navigation function displays only those data-defined dependencies with strengths above an absolute threshold or among the top N dependencies through arrows from other arrays of cell in the spreadsheet.

In one embodiment, advertisements are included based on the data-defined dependencies revealed by the model.

In one embodiment, the invention allows the user to limit the history used for a given firm or for all firms to a given number of accounting periods.

In one embodiment, the invention uses publicly available macroeconomic data along with financial statements to create forecasts.

1. A method for forecasting financial statements of a first company, comprising:
obtaining financial statements of the first company, and optionally of one or more additional companies, as input;
optionally obtaining one or more of the following to add to the input:
(a) user-provided forecasts of particular line items of the financial statements of the first company;
(b) user-provided forecasts of particular line items of the financial statements of said additional companies;
(c) macroeconomic data;
optionally filtering said input;
using all or a subset of the line items of the financial statements of the first company as line items of interest, wherein said subset of the line items can be either user-selected or system-selected;
using the projections of a multidimensional model, which fits the line items of interest as a function of the input, to forecast the line items of interest for the first company.

2. The method of claim 1, further comprising:
quantifying the strengths of data-defined dependencies of the forecasted line items on other line items in the input using said multidimensional model;
optionally rendering to the user said data-defined dependencies meeting a criteria that is either system-defined or user-defined;
optionally guiding the user from a given forecasted line item to one or more other line items on which there is data-defined dependency meeting a criteria that is either user-defined or system-defined.

3. The method of claim 1, wherein obtaining a user-provided forecast of a given financial statement line item of the first company or of one of additional companies comprises:
obtaining from the user, instead of a direct forecast of said given line item, a set of data on which said given line item has a definitional dependency;
aggregating and/or transforming said set of data to create the forecast of said given line item on behalf of the user using said definitional dependency.

4. The method of claim 1, further comprising:
guiding the user through a chain or chains of definitional dependencies of line items on other line items.

5. The method of claim 1, further comprising:
rendering the forecasted line items to the user through a text-based or graphic-based user interface, wherein the interface supports options to format the rendered content.

6. The method of claim 2, further comprising:
navigating the user from a given line item to a successive one through data-defined dependencies by iteratively performing:
(a) quantifying the strength of data-defined dependencies for said given line item on other line items in the input using said multidimensional model and guiding the user from said given line item to a successive line item based on a user-selected or system-selected strength of data-defined dependency;
(b) if the successive line item is not among the original line items of interest, using a second multidimensional model fitting the successive line item as a function of the same input, and repeating step (a) using the successive line item as the given line item.

7. (canceled)

8. A method for analyzing data-defined dependencies of line items in financial statements of a first company, comprising:
obtaining financial statements of the first company, and optionally of one or more additional companies, as input;
optionally obtaining one or more of the following to add to the input:
(a) user-provided forecasts of particular line items of the financial statements of the first company;
(b) user-provided forecasts of particular line items of the financial statements of said additional companies;
(c) macroeconomic data;
optionally filtering said input;
using all or a subset of the line items of the financial statements of the first company as line items of interest, wherein said subset of the line items can be either user-selected or system-selected;
using a multidimensional model which fits the line items of interest as a function of the input to quantify the strengths of data-defined dependencies of the line items of interest on other line items in the input;
optionally guiding the user from a given line item of interest to one or more other line items in the input on which there is a data-defined dependency meeting a criteria that is either user-defined or system-defined.

9. The method of claim 8, further comprising:
navigating the user from a given line item to a successive one through data-defined dependencies by iteratively performing:
(a) quantifying the strength of data-defined dependencies for said given line item on other line items in the input using said multidimensional model and guiding the user from said given line item to a successive line item based on a user-selected or system-selected strength of data-defined dependency;
(b) if the successive line item is not among the original line items of interest, using a second multidimensional model fitting the successive line item as a function of the same input, and repeating step (a) using the successive line item as the given line item.

10. The method of claim 8, further comprising:
guiding the user through a chain or chains of definitional dependencies of line items on other line items.

11. The method of claim 8, further comprising:
rendering to the user, through a text-based or graphic-based user interface, those data-defined dependencies meeting a criteria that is either system-defined or user-defined, wherein the interface supports options to format the rendered content.

12. The method of claim 8, wherein obtaining a user-provided forecast of a given financial statement line item of the first company or of one of additional companies comprises:
obtaining from the user, instead of a direct forecast of said given line item, a set of data on which said given line item has a definitional dependency;
aggregating and/or transforming said set of data to create the forecast of said given line item on behalf of the user using said definitional dependency.

13. (canceled)

14. A system for forecasting financial statements of a first company comprising:
at least one computer;
means for obtaining a first feed of financial statements of the first company;
optional means for obtaining a second feed of financial statements of one or more additional companies;
optional means for obtaining a third feed of user-provided forecasts of particular line items of the financial statements of the first company;
optional means for obtaining a fourth feed of user-provided forecasts of particular line items of the financial statements of said additional companies;
optional means for obtaining a fifth feed of macroeconomic data;
optional means for filtering data from said feed(s);
software executing on said computer(s) for implementing a multidimensional model using said feeds as input to fit a set of line items of interest, wherein said set of line items of interest may be the entirety or a subset of the financial statements line items of the first company;
software executing on said computer(s) for using the projections of said multidimensional model to forecast the line items of interest.

15. The system according to claim 14, further comprising:
software executing on said computer(s) for quantifying data-defined dependencies of the forecasted line items on other line items in the input using said multidimensional model;
optional software executing on said computer(s) for rendering to the user the data-defined dependencies meeting a criteria that is either system-defined or user-defined;
optional software executing on said computer(s) for guiding the user from a given forecasted line item to one or more other line items on which there is a data-defined dependency meeting a criteria that is either user-defined or system-defined.

16. The system according to claim 14, further comprising:
software executing on said computer for indirectly obtaining a user-provided forecast of a given financial statement line item of the first company or of one of the additional companies, said software comprises:
means for obtaining from the user, instead of a direct forecast of said given line item, a set of data on which said given line item has a definitional dependency;
means for aggregating and/or transforming said set of data to create the forecast of said given line item on behalf of the user using said definitional dependency.

17. The system according to claim 14, wherein said computer(s) are a distributed client-server computing system over a network, or a web-based computing system.

18. The system according to claim 14, further comprising:
means for rendering the forecasted line items to the user through a text-based or graphic-based user interface, wherein the interface supports options to format the rendered content.

19. The system according to claim 15, further comprising:
software executable on said computer for navigating the user from one given line item to a successive one, through data-defined dependencies, said software, when executed, causes the computer to iteratively perform the steps comprising:
(a) quantifying the strength of data-defined dependencies for said given line item on other line items in the input using said multidimensional model and guiding the user from said given line item to a successive line item based on a user-selected or system-selected strength of data-defined dependency;
(b) if the successive line item is not among the original line items of interest, using a second multidimensional model fitting the successive line item as a function of the same input, and repeating step (a) using the successive line item as the given line item.

20. The system according to claim 15, wherein said computer(s) are a distributed client-server computing system over a network, or web-based computing system.

21. The system according to claim 15, further comprising:
software executing on said computer for rendering advertisements and/or related links based on the data-defined dependencies meeting a criteria that is either user-defined or system-defined.

22. A system for analyzing data-defined dependencies of line items in financial statements of a first company, comprising:
at least one computer;
means for obtaining a first feed of financial statements of the first company;
optional means for obtaining a second feed of financial statements of one or more additional companies;
optional means for obtaining a third feed of user-provided forecasts of particular line items of the financial statements of the first company;
optional means for obtaining a fourth feed of user-provided forecasts of particular line items of the financial statements of said additional companies;
optional means for obtaining a fifth feed of macroeconomic data;
optional means for filtering data from said feed(s);
software executing on said computer(s) for implementing a multidimensional model using said feeds as input to fit a set of line items of interest, wherein said set of line items of interest may be the entirety or a subset of the financial statement line items of the first company;
software executing on said computer(s) for quantifying the strengths of data-defined dependencies of the line items of interest on other line items in the input using said multidimensional model;
optional software executing on said computer(s) for guiding the user from a given line item of interest to one or more other line items on which there is data-defined dependency meeting a criteria that is either user-defined or system-defined.

23. The system according to claim 22, further comprising:
software executable on said computer for navigating the user from one given line item to a successive one through data-defined dependencies, said software, when executed, causes the computer to iteratively perform the steps comprising:
(a) quantifying the strength of data-defined dependencies for said given line item on other line items in the input using said multidimensional model and guiding the user from said given line item to a successive line item based on a user-selected or system-selected strength of data-defined dependency;
(b) if the successive line item is not among the original line items of interest, using a second multidimensional model fitting the successive line item as a function of the same input, and repeating step (a) using the successive line item as the given line item.

24. The system according to claim 22 wherein said computer(s) are a distributed client-server computing system over a network, or a web-based computing system.

25. The system according to claim 22, further comprising:
means for rendering to the user, through a text-based or graphic-based user interface, those data-defined dependencies that meet a criteria that is either user-defined or system-defined, wherein the interface supports options to format the rendered content.

26. The system according to claim 22, further comprising:
software executing on said computer for indirectly obtaining a user-provided forecast of a given financial statement line item of the first company or of one of the additional companies, said software comprises:
means for obtaining from the user, instead of a direct forecast of said given line item, a set of data on which said given line item has a definitional dependency;
means for aggregating and/or transforming said set of data to create the forecast of said given line item on behalf of the user using said definitional dependency.

27. The system according to claim 22, further comprising:
software executing on said computer for rendering advertisements and/or related links based on the data-defined dependencies meeting a criteria that is either user-defined or system-defined.
